(19) United States
(12) Patent Application Publication
(10) Pub. No.: US 2024/0127159 A1
(43) Pub. Date: Apr. 18, 2024

(54) AUTOMATED DATA MODEL DEPLOYMENT

(71) Applicant: Wells Fargo Bank, N.A., San Francisco, CA (US)

(72) Inventors: Krishnakumar Chellappa, Charlotte, NC (US); Abhishek Desai, Haledon, NJ (US); Amrith Kumar, Charlotte, NC (US); Sahger Lad, Charlotte, NC (US); Manickaselvam Mahalingam, Fort Mill, SC (US); Nagarjuna Tadisetti, Charlotte, NC (US)

(21) Appl. No.: 17/308,478

(22) Filed: May 5, 2021

(51) Int. Cl. G06Q 10/06; G06N 5/04; G06N 20/00

(52) U.S. Cl. CPC G06Q 10/067; G06N 5/04; G06N 20/00; G06Q 10/06313

(57) ABSTRACT

Automated configuration and deployment of models for projects of business enterprises. A model deployment configuration framework includes a template generated at a user interface. The template prompts a user to select model configuration aspects and model operating factors, and submit the selected aspects and factors to configure and deploy the model in a computing environment of the enterprise's computer system for packaging, training, scoring, and/or auditing the model in connection with a project of the enterprise.

### BACKGROUND

Business enterprises use computer modeling to predict outcomes based on large quantities of data. The predicted outcomes can be used to create and modify products and services for customers, to communicate with customers and other parties, and so forth. Typically, large enterprises, such as financial institutions, create, train, test, score and monitor many models for many projects. Before a new model or a new version of a model can be placed into production and thereby relied upon by a business enterprise to generate output relevant to the enterprise's business, the model must be configured such that it can be deployed in the enterprise's computing production environment.

### SUMMARY

Embodiments of the disclosure are directed to a system for configuring models in an efficient manner for deployment and production use by a business enterprise.

Embodiments of the disclosure are directed to a method for configuring models in an efficient manner for deployment and production use by a business enterprise.

According to aspects of the present disclosure, a computer implemented method, includes: generating, with a graphical user interface, a template for a model associated with a project of an enterprise; receiving, with the graphical user interface, selections of jobs of the model and selections of scripts for running the jobs of the model, the selections of jobs and the selections of scripts being received via the template; deploying the model in a computing environment of the enterprise, including using the template to configure and perform the jobs based on the scripts; and running the model in the environment to generate model output for the project.

In another aspect, a system includes: at least one processor; a graphical display; and non-transitory computer-readable storage storing instructions that, when executed by the at least one processor, cause the at least one processor to: generate, with a graphical user interface displayed on the graphical display, a template for a model associated with a project of an enterprise; receive, with the graphical user interface, selections of scripts for running jobs of the model, the selections of scripts being received via the template; deploy the model in a computing environment of the enterprise, including to use the template to configure and perform the jobs; and run the model in the environment to generate model output for the project.

Yet another aspect is directed to a computer implemented method, including: generating, with a graphical user interface, a template for a model associated with a project of an enterprise; receiving, with the graphical user interface, selections of jobs of the model and selections of scripts for running the jobs of the model, the selections of jobs and the selections of scripts being received via the template, the jobs including data processing for the model, feature engineering for the model, scoring the model, and at least one post-scoring job; deploying the model in a computing environment of the enterprise, including using the template to configure and perform the jobs based on the scripts, the deploying further including implementing operating factors for running the jobs, the operating factors being provided using the template, the operating factors including defining a dependency of starting one of the jobs upon completion of another job, the operating factors further causing the model to score, based on an operating factor selection received via the template, either in real-time or using batch processing; receiving, with the graphical user interface: a selection, received via the template, of an input path for each of the jobs; and a selection, received via the template, of an output location for storing an output of each of the jobs; and running the model in the environment to generate model output for the project, the running including running each of the jobs and, for each of the jobs, storing the output in the selected output location.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 schematically shows portions of an example project model configuration system according to the present disclosure.

FIG. 2 shows an example process flow for deploying and running a model in a production computing environment of enterprise according to the present disclosure using the system of FIG. 1.

FIG. 3 schematically shows using a model configuration template of the user interface of FIG. 1 to configure a model for deployment according to the present disclosure.

FIG. 4 shows an example user interface generated by an embodiment of the template of FIG. 3.

FIG. 5 shows an example user interface generated by a further embodiment of the template of FIG. 3.

FIG. 6 shows a further example user interface generated by the template of FIG. 3 according to the further embodiment of the template.

FIG. 7 shows a further example user interface generated by the template of FIG. 3 according to the further embodiment of the template.

FIG. 8 shows a further example user interface generated by the template of FIG. 3 according to the further embodiment of the template.

FIG. 9 schematically shows example physical components of portions of the system of FIG. 1.

### DETAILED DESCRIPTION

Business enterprises, such as financial institutions, utilize computer models to predict outcomes. Such models use algorithms to process data. In some examples, such models can use algorithms that do not rely on machine learning. In some examples, such models can use algorithms that do rely on machine learning. In some examples, such models can use combinations of machine learning and non-machine learnings algorithms.

In some examples, the models can use machine learning algorithms, such as linear regression, logistic regression, support vector machines, and neural networks.

In some examples, the models can use Bayesian networks and/or other machine learning algorithms to identify new and statistically significant data associations and apply statistically calculated confidence scores to those associations, whereby confidence scores that do not meet a predetermined minimum threshold are eliminated. Bayesian networks are algorithms that can describe relationships or dependencies between certain variables. The algorithms calculate a conditional probability that an outcome is highly likely given specific evidence. As new evidence and outcome dispositions are fed into the algorithm, more accurate conditional probabilities are calculated that either prove or disprove a particular hypothesis. A Bayesian network essentially learns over time.

The machine learning algorithms can include supervised and/or unsupervised learning models using statistical methods.

The learning models can be trained to infer classifications. This can be accomplished using data processing and/or feature engineering to parse data into discrete characteristics, identifying the characteristics that are meaningful to the model, and weighting how meaningful or valuable each such characteristic is to the model such that the model learns to accord appropriate weight to such characteristics identified in new data when predicting outcomes.

The learning models can use vector space and clustering algorithms to group similar data inputs. When using vector space and clustering algorithms to group similar data, the data can be translated to numeric features that can be viewed as coordinates in a n-dimensional space. This allows for geometric distance measures, such as Euclidean distance, to be applied. There is a plurality of different types of clustering algorithms than can be selected. Some cluster algorithms such as K-means work well when the number of clusters is known in advance. Other algorithms such as hierarchical clustering can be used when the number of clusters is unclear in advance. An appropriate clustering algorithm can be selected after a process of experimental trial and error or using an algorithm configured to optimize selection of a clustering algorithm.

In some examples, models can be packaged together as a package that integrates and operatively links the models together. For example, the output of one model can serve as the input for another model in the package. Data is fed to the package of models and the models work together to generate outputs, such as predicted outcomes, that can be used by the business enterprise, typically to improve their business in some way. For example, the model outputs can be used to improve the enterprise's profitability, to improve the enterprise's cost of customer acquisition, to improve the enterprise's customer relations, to identify a market in which to enter or expand, to identify a market in which to contract or from which to leave, and so forth.

Typically, in order for an enterprise to train, test and run a model, the model must be onboarded to a computing environment generated and managed by the enterprise. The computing environment can be generated by computing hardware, firmware, middleware and software that are privately owned and/or operated by the enterprise. Alternatively, the computing environment can be generated using shared computing resources. Non-limiting examples of such environments for a given enterprise, such as a financial institution, include a development environment, a testing environment, a pre-production environment, and a production environment.

The development environment can be used to define and create the framework for a product or project of the enterprise. The testing environment can be used to test whether the product or project is operable. The pre-production environment can be used for further quality checks and high level testing, as well as approvals of a model by managers and other stakeholders of the enterprise who are managing the project.

The production environment can be used to actually launch the product or project. Thus, for example, the production environment is used to run a model and generate output that is used by the enterprise.

In a particular use example, referred to herein as the targeted student loan promotion project, or TSLPP, a business enterprise (in this case, a financial institution) creates a project to improve how the institution selects customers or prospective customers to whom the institution promotes a particular product (in this case, a student loan), and improves how those customers or prospective customers are communicated the offer or promotion by the financial institution.

The goals of TSLPP, from the standpoint of the financial institution, are to maximize the number of student loans issued by the financial institution and minimize the number of student loan promotions or offers by the financial institution that are ignored or rejected. Offers or promotions that are made to uninterested parties can waste resources of the enterprise and have a further deleterious effect of irritating or bothering the recipients of those offers or promotions, which could sour the existing or potential customer relationship with the financial institution.

Continuing with the TSLPP example, a 75 year-old, controlled for other variables, may be less likely to be interested in a student loan than a 17 year-old. A high school student who has signed with a professional sports team, controlled for other variables, may be less likely to be interested in a student loan than one who has not signed with a professional sports team. A high school student belonging to a family of high net worth, controlled for other variables, may be less likely to be interested in a student loan than a high school student of significantly lower net worth. The TSLPP is configured to use one or more data models to predict such outcomes and their relative likelihoods, and to generate a recommendation (e.g., a recommendation to promote or not to promote a student loan to each of the financial institutions current family customers) or perform an action (e.g., automatically send a promotion to one family and not send a promotion to another family) based on the predicted outcomes generated by the one or more data models.

Continuing with the TSLPP example, a family having an otherwise suitable candidate family member for a student loan promotion that is currently located overseas may be more likely, controlled for other variables, to receive and consider a student loan promotion that is communicated to the family electronically than in a letter mailed to their domestic residence. A family having an otherwise suitable candidate family member for a student loan promotion that has opted to receive no electronic communications from the financial institution of which it is a customer, and conducts all banking in person at a local brick and mortar branch of the financial institution may be more likely, controlled for other variables, to be receptive of and consider a student loan promotion that is made to the family by a human employee of the financial institution the next time the family visits their local branch. The TSLPP is configured to use one or more data models to predict such outcomes and their relative likelihoods, and to generate a recommendation (e.g., a recommendation to communicate a student promotion to a particular family in person at their next visit to the local branch) or perform an action (e.g., automatically send a student loan promotion to a family by email) based on the predicted outcomes generated by the one or more data models.

The development environment can be used to define the goals and other parameters of TSLPP, and build the models and model package that will be used to execute the project. The development environment can be used to train the models of the TSLPP and ensure that the model results are sensible. For example, the models can be trained and tested with sets of training data with known outcomes. Through application of feature engineering and/or data processing, features and/or other aspects of the data can be identified as more relevant or less relevant to model outcomes, and the underlying model algorithms can be adjusted accordingly.

The testing environment can be used to test the models of the TSLPP for appropriate outcomes. For example, the models can be tested with a set of testing data with known outcomes that is different from the training data.

The pre-production environment can be used to further test the models of the TSLPP, and for review and approval of the project and/or underlying model(s) by managing stakeholders.

The production environment can be used to actually run the project and generate results that can be used by the financial institution. For example, the TSLPP is run (e.g., scored) in the production environment, generating appropriate targets for student loan promotions, determining optimal communications means for communicating those promotions and, in some examples, automatically outputting the promotions via the determined communications means (e.g., automatically sending an email, a text message, a social media message, a voicemail message, etc.).

Onboarding a model or package of models to a computing environment of an enterprise can be a highly time consuming process. Deploying a model in an enterprise's production environment can be especially complex and time consuming process. Each model, and each job of each model, typically must be reconfigured to be compatible with the hardware, firmware, middleware and software of the production environment of the enterprise. For example, a model can be developed by a freelance data scientist who may not be a direct employee of the enterprise for whom they are developing the model. The data scientist building the model may use a variety of different model tool libraries to build the model. In addition, the data engineer building the model may not even have access to the relevant computing environment(s) of the enterprise. Thus, there is a high likelihood that the initial configuration of the model will not be compatible with the enterprise's computing environments, such that the models have to be reconfigured for compatibility. As a result, and as is typical, the reconfiguration that must be performed as part of the model deployment process must be done largely manually by stakeholders of the enterprise. The manual reconfiguration process can take several months or more to complete, causing substantial delays between conception of a project and launch of the project, resulting in significant costs incurred by the enterprise.

Deployment into the production environment can be particularly time consuming and complex due to the various disparate aspects, or jobs, of a model that must be integrated and made compatible with one another at the production environment stage, in order for the model to run smoothly. Such disparate aspects, or jobs, can include a data processing job, a feature engineering job, a scoring job, and output storing job, and a post-output performance or auditing job. In addition, each job typically takes in multiple inputs and processes them in a job processing pipeline to produce the job output that is used by the model. Integrating disparate processing pipelines for different jobs of a model into the production environment of an enterprise in order to deploy the model has been an historically complex and time consuming process.

Aspects of the present disclosure relate to automating aspects of deploying models into a computing environment (e.g., a production environment) of an enterprise using a model automation framework (MAF). That is, aspects of the present disclosure use a model automation framework to streamline model configuration and deployment such that the model can be used by an enterprise in a production computing environment of the enterprise.

By automating aspects of model deployment, several advantages and practical applications are realized. For example, embodiments of the present disclosure minimize potential points of human error by reducing the amount of manual reconfiguring of models.

Further practical applications of embodiments of the present disclosure include significantly reducing the amount of time it takes to deploy and make use of a computer data processing model, improving business transactions and customer experiences with the business enterprise. In some examples, embodiments of the present disclosure reduce model deployment times for a given enterprise by a factor of five, a factor of ten, or more. For example, a manual deployment process that typically takes about six to eight months can be reduced to four weeks, two weeks, or less than one week, using embodiments of the present disclosure.

Further practical applications of embodiments of the present disclosure include improving data processing models that use machine learning algorithms. For example, by shortening the time between model creation and model launch, there is less intervening time in which data used to train the model can become stale or outdated, which could reduce the accuracy and reliability of the implemented model. Thus, embodiments of the present disclosure can increase accuracy and reliability of deployed models.

Further practical applications of embodiments of the present disclosure include the standardization, across an enterprise, of sourcing scripts executed in job processing pipelines of models used by the enterprise, such as pipelines of data processing jobs, feature engineering jobs, model scoring jobs, model output storage jobs, one or more model performance jobs, and so forth. Standardization improves efficiency in model deployment, reduces errors, and decreases retooling and repair times for models that need to be serviced.

Further practical applications of embodiments of the present disclosure include the generation of graphical interfaces that present a model deployment configuration template to realize one or more of the model deployment aspects of the present disclosure in a highly structured and optimized format that allows a user to quickly, reliably, and with minimal effort, fully deploy a model to a selectable computing environment (e.g., the production environment) of the business enterprise.

Further practical applications of embodiments of the present disclosure include streamlining updates and reconfigurations of existing models using a model configuration template.

Further practical applications of embodiments of the present disclosure include the generation of graphical interfaces that present a model deployment configuration template that enables scheduling of a scoring job for a model according to a desired operating factor for the model selected via the template. For example, the operating factor can cause model scoring to take place in a batch, (e.g., according to a predefined schedule), or in real-time. Depending on the model and what the model is being used for, batch or real-time scoring may be desirable. For example, if the model is being used to detect fraudulent transactions, real-time scoring may be more appropriate than batch scoring. Other advantageous operating factors enabled by the model deployment template can include job dependencies, whereby the commencement of one job processing pipeline depends on the completion of another job.

Further practical applications of embodiments of the present disclosure include using the model deployment configuration template of the present disclosure to quickly and easily access component parts (e.g. jobs, operating factors) of an already built and deployed model, and modify one or more of those components using the template to create a new version of the model that can then be easily deployed and run using the template.

Additional advantages and practical applications are borne out by this disclosure.

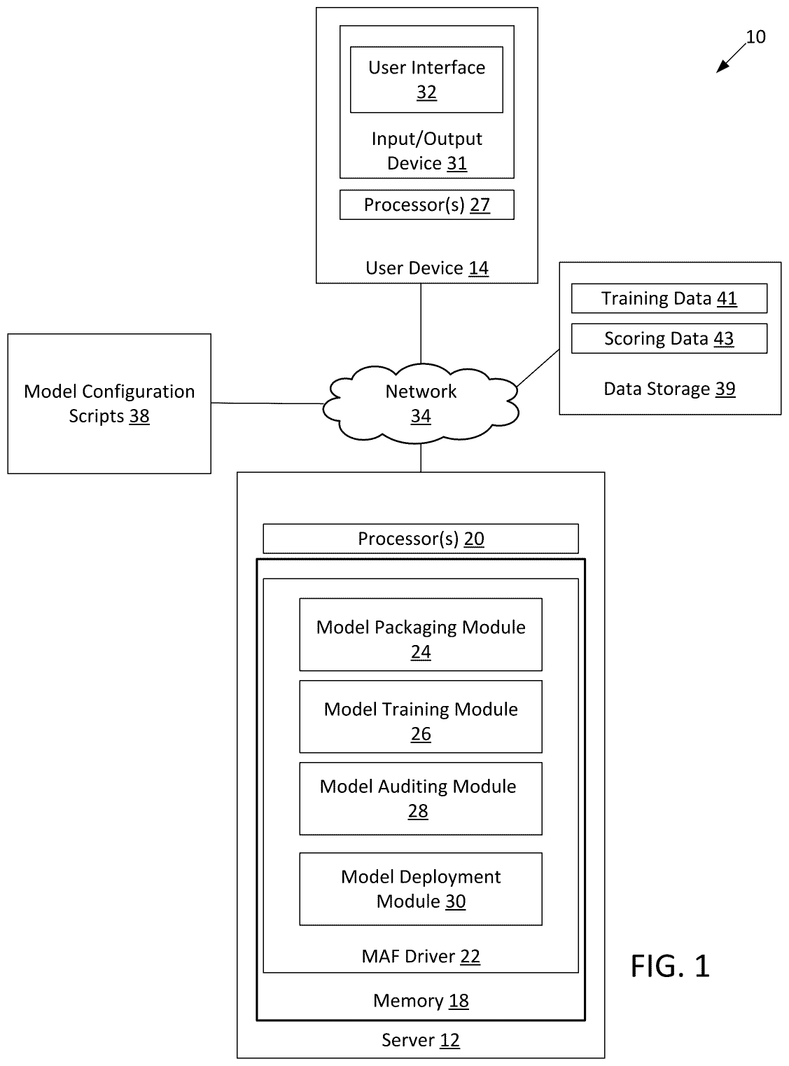

FIG. 1 schematically shows components of an example system 10 according to the present disclosure. The system 10 includes a server 12, a user device 14, computer executable scripts 38 and a data storage (e.g., one or more databases) 39.

The user device 14 is a computing device, such as a laptop computer, a desktop computer, a tablet computer, a smartphone, etc. The user device 14 includes one or more processors 27 configured to execute computer readable instructions that process inputs and generate outputs. Inputs and outputs are provided via the input/output (I/O) device 31 of the user device 14. The I/O device 31 can include one or more of a microphone, a speaker, a graphical display, a key pad, a keyboard, a touchpad, a touchscreen, a mouse, and so forth. The I/O device 31 includes a user interface 32, which can be provided via a graphical display, such that the I/O device can generate graphical user interfaces. The processor 27 is configured to generate a model deployment configuration template on a graphical display using the user interface 32, as described in more detail below.

The processor(s) 27 can process data and execute computer readable instructions for performing functions of the user device 14, such as displaying a model deployment configuration template, and receiving template inputs.

The server 12 is a computing device configured to provide an automated model framework and automate model deployment to a computing environment of a business enterprise, such as the production environment of a financial institution. The server 12 can also define, or partially define, one or more of the different computing environments of the enterprise, such as a development environment, a testing environment, a pre-production environment, and a production environment, as described above. Other environments are also within the scope of this disclosure.

The server 12 includes a memory 18 that stores a MAF driver 22. The MAF driver 22 includes non-transitory computer readable instructions for executing a model automation framework and automating one or more aspects of model deployment. The MAF driver 22 includes a model packing module 24, a model training module 26, a model auditing module 28, and a model runtime module 30.

The server 12 can be associated with a given business enterprise, such as a financial services institution. The server 12 can be configured to be accessed only by the institution to which it is associated. Alternatively, the server 12 can correspond to shared computing resources, such as a cloud, to which a given enterprise can gain access for their private computing needs.

The server 12 includes one or more processor(s) 20 configured to process data and execute computer readable instructions stored on the memory 18 for performing functions of the server 12 described herein.

The system 10 includes one or more model configuration scripts 38 for use by the modules 24, 26, 28 and 30 including scripts, e.g., for use in the job processing pipelines executed by the model deployment module 30. In some examples, one or more of the scripts 38 are stored in one or more libraries that are maintained and operated externally from the enterprise. In some examples, one or more of the scripts 38 are stored in a database internal to the enterprise. In some examples, one or more of the scripts 38 can be configured according to a standard configuration that can be used across the enterprise or portions of the enterprise, and across different models. The scripts 38 can include scripts used by machine learning tools. The scripts 38 can includes scripts used by non-machine learning tools. The scripts 38 can include data processing algorithms. The scripts 38 can include scripts for model packaging tools. The scripts 38 can include scripts for model training algorithms. The model training algorithms can include data processing scripts and/or feature engineering scripts for meaningfully parsing and classifying pieces of data. The scripts 38 can include scripts for model scoring algorithms and scheduling algorithms for scoring (e.g., batch scoring algorithms and real-time scoring algorithms). The scripts 38 can include post-scoring scripts for auditing and/or monitoring model outputs.

The system 10 includes a data storage 39, which can correspond to one or more databases. The databases can be privately owned and operated by the business enterprise or be shared computing resources to which a given enterprise can gain access for their private computing needs. The data storage 39 stores training data 41 and scoring data 43. In some examples, the training data 41 and the scoring data 43 are associated with the business enterprise, e.g., are data collected by the business enterprise during the course of running its business.

The training data 41 and/or the scoring data 43 can be obtained from any of a number of different sources, including automated electronic data acquisition devices. For example, data can be obtained from audio sessions with a customer or prospective customer of the business enterprise. An automatic speech recognition device and natural language processor can digitalize the speech and parse the digitalized speech into information about a customer or prospective customer. An image scanner can be used to obtain data from a paper document, which can then be parsed for information about a customer or prospective customer. A web crawling machine can obtain data from various webpages containing information relevant to a customer or prospective customer. A transaction card reader that automatically obtains information about a customer when, e.g., the customer executes a transaction with their transaction card at the transaction card reader, can be used to obtain information about a customer that can be committed to the training data 41 and/or the scoring data 43.

The training data 41 and/or the scoring data 43 can also be obtained from other third party sources or databases. Such databases can include, for example, government databases that store taxpayer information, statutory and regulatory information, zoning information, property lien information, survey and title information, homeowners' association information, and so forth. Other databases can include those of credit rating associations, real estate organizations, financial aggregator organizations, other financial institutions, insurance providers, etc. In some examples, pre-authorization may be needed, e.g., from the customer, before the business enterprise is granted access to information related to the customer or prospective customer from one or more of these databases.

Other examples of data acquisition and data sources are within the scope of this disclosure.

For example, for the TSLPP use case, the training data 41 can include customer profile data (name, address, phone number, age, types of financial accounts, net worth, assets, account preferences, account permissions, family information, information about promotional offers made by the enterprise to the customer and information about promotional offers accepted by the customer) for all customers who have been issued a promotion for a student loan in the past.

Continuing with the TSLPP use case example, the scoring data 43 can include customer profile data and/or prospective customer profile data for all customers and/or prospective customers of the financial institution who have not been previously considered for a student loan promotion. A goal of the TSLPP is to train one or more models using student loan promotion success and failure data, and the underlying characteristics of those customers, in the training data 41 to predict outcomes and make recommendations and determinations for the likelihood of success if issuing promotions, and the optimal communication means of issuing such promotions, to customers and prospective customers represented in the scoring data 43.

The server 12, the user device 14, the scripts 38, and the data storage 39 are interconnected via a network 34. The network 34 can be any suitable data network, such as the internet, a wide area network, a local area network, a wired network, a wireless network, a cellular network, a satellite network, a near field communication network, or any operatively connected combination of these. Inputs to the user device 14 can be received by the server 12 via the network 34 and vice versa. In addition, the server 12 can access the scripts 38 for use by the MAF driver 22 via the network 34. In addition, the server 12 can access the training data 41 and the scoring data 43 for use by the MAF driver 22 via the network 34.

The model packaging module 24 is configured to generate a portion of a model configuration template for configuring a model using the MAF driver 22. The template is displayed via the user interface 32. The portion of the template generated by the model packaging module 24 can be configured to prompt for, and receive, selections for scripts for packaging a model with another model, or packaging together different model tools, for use for by the model that is to be configured. The model packaging module 24 is also configured to process inputs provided via the template pertaining to model packaging. In some examples, the inputs are selected from pre-defined (e.g., standardized) options identified by the model packaging module 24. The model packaging module 24 can also link the MAF driver 22 to the appropriate scripts 38, training data 41, and/or scoring data 43 to be used by the model as configured according to the template inputs.

The model training module 26 is configured to generate another portion of the model configuration template relating to training the model being configured by the MAF driver 22. The portion of the template generated by the model training module 26 can be configured to prompt for, and receive, selections for scripts relating to model training aspects. The model training module 26 is also configured to process inputs provided via the template pertaining to model training. In some examples, the inputs are selected from pre-defined (e.g., standardized) options identified by the model training module 26. The model training module 26 can also link the MAF driver 22 to the appropriate scripts 38, training data 41, and/or scoring data 43 to be used by the model as configured according to the template inputs.

The model deployment module 30 is configured to generate another portion of the model configuration template relating to deploying the model being configured by the MAF driver 22. Deploying a model refers to integrating the model into the enterprise's production environment and using the model in the production environment to generate predicted outcomes for a population that are relevant to a project of a business enterprise. Deploying the model can include, for example, scoring the model using the scoring data 43. The portion of the template generated by the model deployment module 30 can be configured to prompt for, and receive, selections for scripts relating to model deployment jobs and their associated processing pipelines, including, e.g., data processing jobs, feature engineering jobs, scoring jobs, model output storage jobs, and model performance jobs. The model deployment module 30 is also configured to process inputs provided via the template pertaining to model running, such as scoring scheduling factors (e.g., batch versus real-time, job dependencies, and so forth). In some examples, the inputs are selected from pre-defined (e.g., standardized) options (e.g., pre-defined deployment job scripts from the scripts 38) identified by the deployment module 30. The deployment module 30 can also link the MAF driver 22 to the appropriate scripts 38 and/or scoring data 43 to be used by the model as configured according to the template inputs.

The model auditing module 28 is configured to generate another portion of the model configuration template relating to auditing an already scored model being configured by the MAF driver 22. Auditing the model can include, for example, job logging, job monitoring, identifying input and output errors and inconsistencies that have occurred during scoring of the model. The portion of the template generated by the model auditing module 28 can be configured to prompt for, and receive, selections for scripts relating to post-scoring model auditing. The model auditing module 28 is also configured to process inputs provided via the template pertaining to model auditing, such as auditing scripts. In some examples, the inputs are selected from pre-defined (e.g., standardized) options (e.g., pre-defined auditing scripts from the scripts 38) identified by model auditing module 28. The model auditing module 28 can also link the MAF driver 22 to the appropriate scripts 38, training data 41, and/or scoring data 43 to be used by the model as configured according to the template inputs.

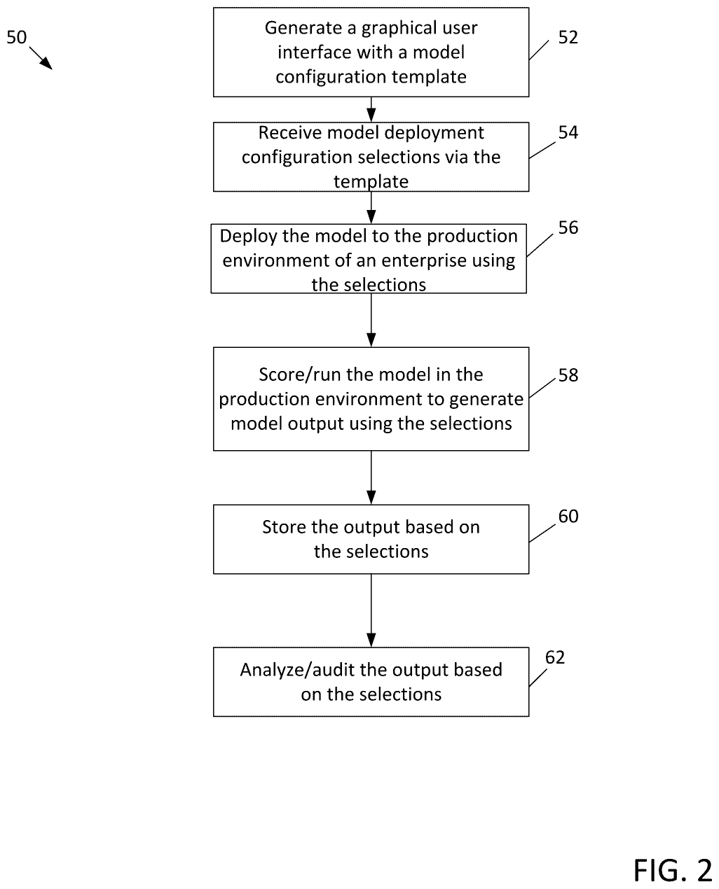

FIG. 2 shows an example process flow 50 for configuring a model for deployment in a production environment of an enterprise according to the present disclosure using the system of FIG. 1.

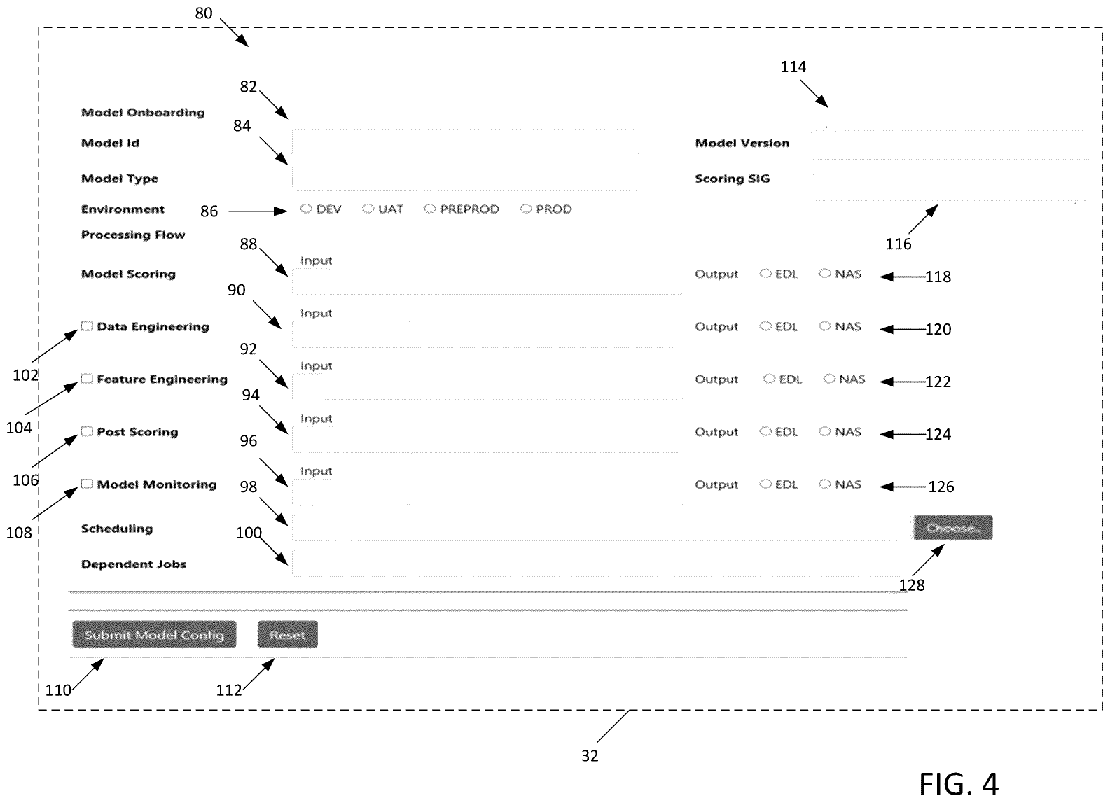

At a step 52 of the process flow 50, one or more graphical user interfaces of a model deployment template are generated. The graphical user interface(s) can be displayed on a graphical display of the I/O device 31 (FIG. 1). Example embodiments of the user interfaces of such a template will be discussed in greater detail in connection with FIGS. 4-8.

For example, for the TSLPP use case, the template interface(s) can be generated in response to a template generation command entered by a data scientist building a model for TSLPP. In some examples, the template can also be accessed by one or more stakeholders of the financial institution who are interested in training, testing, deploying, and/or auditing a TSLPP model.

At a step 54 of the process flow 50, model deployment configuration aspects are selected using the template. Such aspects can include, e.g., scripts for job pipelines, operating factors, and a selection of the production environment for deployment.

For example, for the TSLPP use case, at the step 54, selections of one or more of data processing, feature engineering, scoring, job output storage, and/or post-scoring job scripts and one or more operating factors for the scoring job are selected and received via the template.

At a step 56 of the process flow 50, the template is used to deploy the model to the enterprise's production environment. The deployment includes integrating the jobs selected using the template. This integration is performed by the MAF driver 22 (FIG. 1).

At a step 58 of the process flow 50, the model is scored/run in the production environment using the model configuration selections entered via the template, and the model generates outputs. For example, for the TSLPP use case, at the step 58, the model generates candidates for student promotions and recommendations for communicating the promotions according to the jobs and operating factor(s) selected via the template.

At a step 60 of the process flow 50, the output from step 58 is stored based on output storage selections made via the template.

At a step 62 of the process flow 50, the output of the model is analyzed. The output can be analyzed in real-time (e.g., monitoring of the model output) or after the fact (e.g., auditing the stored outputs) by identifying and accessing the selected output storage locations. Following the step 60, the configured model can be, optionally, operated in the computing environment to which it has been exported at any of the steps 62, 64, 66.

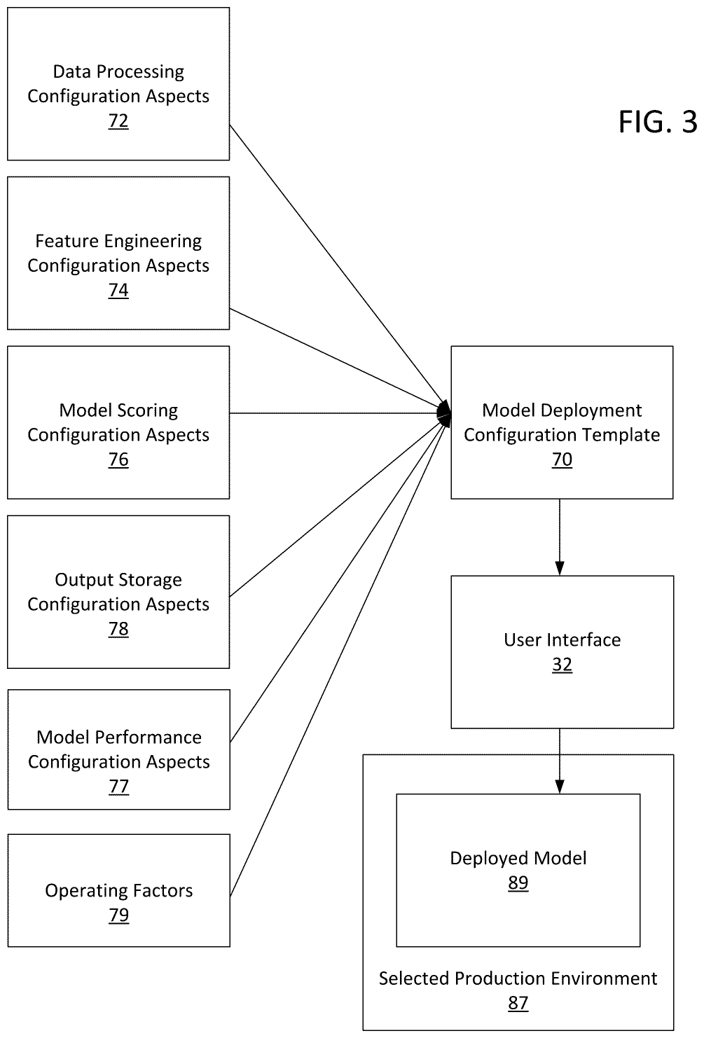

FIG. 3 schematically shows using a model configuration template 70 of the user interface 32 of FIG. 1 to configure a model deployment according to the present disclosure. In this example, the model deployment configuration template 70 is generated by the server 12, although other configurations are possible.

As shown in FIG. 3, the model configuration template 70 prompts for, and receives various model deployment configuration inputs. In some examples, these model deployment configuration inputs can include one or more of model packaging configuration aspects, and/or model training and/or testing aspects. The packaging configuration can include, for example, selection of one or more predefined (e.g., standard) model packaging scripts (or input pathways for such scripts) compatible with the enterprise's computing platforms. In some examples, the packaging configuration aspects include selection of one of a predefined set of model types, which automatically maps the model configuration to a model packaging script corresponding to the model type.

In the depicted example, the inputs include one or more of: data processing configuration aspects 72, feature engineering configuration aspects 74, model scoring configuration aspects 76, model output storage configuration aspects 78, model performance configuration aspects 77, and operating factors 79.

Each input 72, 74, 76, 77, 78, 79 can include a pathway to a script 38 (FIG. 1) that is compatible and automatically integratable, using the MAF driver 22 (FIG. 1) with the scripts of the other inputs upon deployment of the model. Depending on the job, each input 72, 74, 76, 77, 78, 79 can also include a pathway to data inputs on which the corresponding script(s) are performed. In some examples, the selected data inputs can include the output of another job of the model. Each input 72, 74, 76, 77, 78, 79 can also include a pathway to a storage location where model scoring outputs are to be stored.

Depending on the model, each input 72, 74, 76, 77, 78, and 79 can include more or fewer configuration selections (e.g., more or fewer script pathway selections) made via the template, e.g., based on the number and type of features engineered by the model, how the model is scored, the number and types of data sources used to score the model, and so forth.

Once the necessary aspects are entered into the template, the template can be submitted, using the user interface 32, causing the model to be configured and deployed by the MAF driver 22 (FIG. 1) according to the template inputs 72, 74, 76, 77, 78, 79 as a deployed model 89 for use in the enterprise's production environment 87 selected via the template.

FIG. 4 shows an example interface 80 according to embodiment the template 70 of FIG. 3. The interface 80 is displayed using a graphical display of the user interface 32 (FIG. 1). The interface 80 employs the template 70 (FIG. 3) to build and deploy a model in a selectable computing environment (e.g., the production environment) of the enterprise.

The interface 80 includes a field 82 for entering a model ID for a model to be configured for deployment using the interface 80.

The interface 80 includes a field 84 for entering a type of the model to be configured for deployment using the interface 80. In some examples, the field 84 can be pre-populated, e.g., using a dropdown menu, with a selectable pre-defined (e.g., standard) model types. In some examples, the model type is used by the MAF driver 22 (FIG. 1) to create a package using the model to be configured. In some examples, one or more scripts 38 (FIG. 1) are identified for configuring the model based on the model type entered into the field 84. In some examples, a selectable entry into the field 84 includes a pathway for accessing a packaging script or group of scripts.

The interface 80 includes a field 114 for entering a model version of the model being configured. The version can be a current version or a prior version. For example, a stakeholder testing a model may want to look at the evolution of the model by accessing prior versions thereof. In some examples, the field 114 can be pre-populated, e.g., using a dropdown menu, with a selectable pre-defined (e.g., standard) model versions, e.g., based on the number of versions that exist for the model in question.

The interface 80 includes a field 116 for entering an instance group. The instance group indicates the server configuration and/or resource allocation for any jobs executed by the model being deployed and built using the template.

The interface 80 includes radio buttons 86 for selecting a desired computing environment of the business enterprise to which to onboard the configured the model. In the example shown, there are selectable radio buttons 86 for each of a development (DEV) environment, a test (UAT) environment, a pre-production (PREPROD) environment, and a production (PROD) environment. For full deployment of the model using the interface 80, radio button 86 corresponding to the production environment is selected.

The interface 80 includes a model scoring input field 88 and selectable output radio buttons 118. The input field 88 is associated with a model scoring job for the model to be configured via the interface 80 (i.e., the model identified in the field 82). To provide a model scoring job processing pipeline for the model, the input field 88 is configured for entering, e.g., a predefined scoring script and/or a predefined dataset (e.g., the scoring data 43 (FIG. 1)) to apply the selected scoring script for scoring the model to be configured via the template. In some examples, the output of another model job can be selected and entered into the input field 88, such as the output from a model training job. In some examples, the field 88 can be pre-populated, e.g., using a dropdown menu, with selectable pre-defined (e.g., standard) scoring scripts, datasets, and/or outputs from other model jobs, and/or pathways thereto. Similarly, each such dataset can be linked to a corresponding database that stores the data. Similarly, each such output from another modeling job can be linked to a corresponding database that stores the output. As mentioned, in some examples, a selectable entry into the field 88 includes an input pathway for accessing a scoring script, an output of another job, or a dataset by the MAF driver 22 (FIG. 1).

The output radio buttons 118 are selectable for exporting the output of the scoring job associated with the field 88 to a selected one of predefined locations, including a remote repository (EDL) and a local repository (NAS). If another job performed by the model uses the output of the scoring job pipeline, it accesses the output based on the repository selection between the radio buttons 118.

The interface 80 includes a toggle button 102. The toggle button 102 is selected when the particular version of the model being deployed requires a data processing job pipeline as part of running the model in the selected computing environment. An example of data processing is identifying datasets that are pertinent to predicting the outcomes sought by the project using the model. For example, in the TSLPP use case, data processing can include determining which dataset(s) to use (e.g., a customer data set versus an employee dataset) to build and train a model that can predict which customers are likely to be receptive to student loan promotions and the best means of communicating those promotions.

The interface 80 includes a data processing (or engineering) input field 90 and selectable output radio buttons 120 that are utilized when the toggle button 102 is selected. To provide the deployed model with a data processing pipeline, the input field 90 is configured for entering, e.g., a predefined data processing script and/or a predefined dataset (e.g., the training data 41 and/or the scoring data 43 (FIG. 1)) to apply the selected data processing script to the model to be configured for deployment by the MAF driver 22 (FIG. 1) using the interface 80. In some examples, the output of another model job can be selected and entered into the input field 90, such as the output from another model training job pipeline. In some examples, the field 90 can be pre-populated, e.g., using a dropdown menu, with selectable pre-defined (e.g., standard) data processing scripts, datasets, and/or outputs from other model jobs or input pathways thereto. Each such script can be linked to a corresponding location that stores the script for access and use. Similarly, each such dataset can be linked to a corresponding database that stores the data. Similarly, each such output from another model job can be linked to a corresponding database that stores the output. As mentioned, in some examples, a selectable entry into the field 90 includes an input pathway for accessing a data processing script, an output of another job pipeline, or a dataset by the MAF driver 22 (FIG. 1).

The output radio buttons 120 are selectable for exporting the output of the data processing job pipeline associated with the field 90 to a selected one of predefined locations, including a remote repository (EDL) and a local repository (NAS). If another job used by the model uses the output of the data processing job pipeline, it accesses the output based on the repository selection between the radio buttons 120.

The interface 80 includes a toggle button 104. The toggle button 104 is selected when the particular version of the model being configured for deployment requires a feature engineering pipeline as part of the deployment, e.g., as part of the deployment in the production environment. An example of feature engineering is identifying features in data that are pertinent to predicting the outcomes sought by the project using the model, and weighting their respective pertinence. For example, in the TSLPP use case, feature engineering can include weighting the meaningfulness of a customer's net worth and a customer's gender when building and training a model that can predict which customers are likely to be receptive to student loan promotions and the optimal means of communicating those promotions.

The interface 80 includes a feature engineering input field 92 and selectable output radio buttons 122 that are utilized when the toggle button 104 is selected. The input field 92 is associated with a feature engineering job pipeline for the model to be configured for deployment via the interface 80 (i.e., the model identified in the field 82). To provide feature engineering for the model, the input field 92 is configured for entering, e.g., a predefined data processing script and/or a predefined dataset (e.g., the training data 41 and/or scoring data 43 (FIG. 1)) to apply the selected feature engineering script to the model to be configured by the MAF driver 22 (FIG. 1) using the interface 80. In some examples, the output of another model job pipeline can be selected and entered into the input field 92, such as the output from another model job. In some examples, the field 92 can be pre-populated, e.g., using a dropdown menu, with a selectable pre-defined (e.g., standard) feature engineering scripts, datasets, and/or outputs from other model jobs, or pathways thereto. Each such script can be linked to a corresponding location that stores the script for access and use. Similarly, each such dataset can be linked to a corresponding database that stores the data. Similarly, each such output from another modeling job can be linked to a corresponding database that stores the output. As mentioned, in some examples, a selectable entry into the field 92 includes a pathway for accessing a feature engineering script, an output of another job, or a dataset by the MAF driver 22 (FIG. 1).

The output radio buttons 122 are selectable for exporting the output of the feature engineering job pipeline associated with the field 92 to a selected one of predefined locations, including a remote repository (EDL) and a local repository (NAS). If another job used by the model uses the output of the feature engineering job, it accesses the output based on the repository selection between the radio buttons 122.

The interface 80 includes a toggle button 106. The toggle button 106 is selected when the particular version of the model being deployed and configured requires post-scoring analysis following deployment. An example of post-scoring analysis for the TSLPP use case is identifying inconsistencies in how the model predicted outcomes for two similarly situated customers.

The interface 80 includes a post scoring input field 94 and selectable output radio buttons 124 that are utilized when the toggle button 106 is selected. The input field 94 is associated with a model auditing job for the model to be configured for deployment via the interface 80 (i.e., the model identified in the field 82). To provide a model auditing job pipeline for the model, the input field 94 is configured for entering, e.g., a predefined post scoring script and/or a predefined dataset (e.g., the scoring data 43 (FIG. 1)) to apply the selected post scoring script to the model to be configured by the MAF driver 22 (FIG. 1) using the interface 80. In some examples, the output of another model job can be selected and entered into the input field 94, such as the output from a model scoring job. In some examples, the field 94 can be pre-populated, e.g., using a dropdown menu, with selectable pre-defined (e.g., standard) post scoring scripts, datasets, and/or outputs from other model jobs, or pathways thereto. Each such script can be linked to a corresponding storage location that stores the script for access and use. Similarly, each such dataset can be linked to a corresponding database that stores the data. Similarly, each such output from another modeling job can be linked to a corresponding database that stores the output. As mentioned, in some examples, a selectable entry into the field 94 includes a pathway for accessing a post scoring script, an output of another job, or a dataset by the MAF driver 22 (FIG. 1).

The output radio buttons 124 are selectable for exporting the output of the auditing job associated with the field 96 to a selected one of predefined locations, including a remote repository (EDL) and a local repository (NAS). If another job used by the model uses the output of the auditing job, it accesses the output based on the repository selection between the radio buttons 124.

The interface 80 includes a toggle button 108. The toggle button 108 is selected when the particular version of the model being configured and deployed in the enterprise's production environment requires monitoring. An example of monitoring analysis is checking performance in real-time of an active model by, e.g., comparing model scoring outputs to known data that definitively determines whether the model output is accurate.

The interface 80 includes a monitoring input field 96 and selectable output radio buttons 126 that are utilized when the toggle button 108 is selected. The input field 96 is associated with a model auditing job for the model to be configured via the interface 80 (i.e., the model identified in the field 82). To provide a model auditing job for the model, the input field 96 is configured for entering, e.g., a predefined monitoring script and/or a predefined dataset (e.g., the scoring data 43 (FIG. 1)) to apply the selected monitoring script to the model to be configured and deployed by the MAF driver 22 (FIG. 1) using the interface 80. In some examples, the output of another model job can be selected and entered into the input field 96, such as the output from a model scoring job. In some examples, the field 96 can be pre-populated, e.g., using a dropdown menu, with selectable pre-defined (e.g., standard) monitoring scripts, datasets, and/or outputs from other model jobs, or pathways thereto. Each such script can be linked to a corresponding location that stores the script for access and use. Similarly, each such dataset can be linked to a corresponding database that stores the data. Similarly, each such output from another modeling job can be linked to a corresponding database that stores the output. As mentioned, in some examples, a selectable entry into the field 96 includes a pathway for accessing a monitoring script, an output of another job, or a dataset by the MAF driver 22 (FIG. 1).

The output radio buttons 126 are selectable for exporting the output of the auditing job associated with the field 96 to a selected one of predefined locations, including a remote repository (EDL) and a local repository (NAS). If another job used by the model uses the output of the auditing job, it accesses the output based on the repository selection between the radio buttons 122.

The interface 80 includes a scheduling input field 98. The input field 98 is associated with a model runtime job for the model to be configured via the interface 80 (i.e., the model identified in the field 82). To provide a model runtime job for the model, the input field 98 is configured for entering, e.g., a predefined scheduling script to apply the selected scheduling script to the model to be configured by the MAF driver 22 (FIG. 1) using the interface 80. In some examples, the field 98 can be pre-populated, e.g., using a dropdown menu, with selectable pre-defined (e.g., standard) scheduling scripts. The selected scheduling script sets conditions under which the model is scored (e.g., as a batch or in real-time), or particular jobs of the model are run. In some examples, a selectable entry into the field 98 includes a pathway for accessing an input scheduling script by the MAF driver 22 (FIG. 1). A button 128 can be clicked to submit the selected scheduling script or pathway.

The interface 80 includes a dependent jobs input field 100. The input field 100 is associated with another model runtime job for the model to be configured via the interface 80 (i.e., the model identified in the field 82). To provide a model runtime job for the model, the input field 100 is configured for entering, e.g., one or more tasks performed by jobs of the model to be deployed, or jobs of another model, that must be completed prior to deploying the model by the MAF driver 22 (FIG. 1) using the interface 80. In some examples, the field 100 can be pre-populated, e.g., using a dropdown menu, with selectable pre-defined (e.g., standard) other tasks, or pathways thereto. In some examples, a selectable entry into the field 100 includes a pathway to another task that must be completed prior to running the model configured according to the interface 80. For example, the model can be operatively linked to another model in order to properly execute the project of the business enterprise. The model may require the predicted outcomes of the other model in order to run properly. Thus, a pathway to the output of the other model can be selected as a dependent task in the field 100.

The interface 80 includes a reset button 112, which is selectable to reset the various fields in the template prior to submission.

The interface 80 includes a button 110 selectable to submit the template to the MAF driver 22 (FIG. 1), causing the MAF driver 22 to configure the model into a configured model 89 (FIG. 3) according to the information entered into the interface 80. Selecting the button 110 also causes the configured model to be onboarded to the environment 87 (FIG. 3) selected via the radio buttons 86. If the production environment has been selected using the interface 80, selection of the button 110 causes the MAF driver 22 (FIG. 1) to integrate the model's jobs and their processing pipelines in the enterprise's production environment, to thereby deploy the model in the production environment.

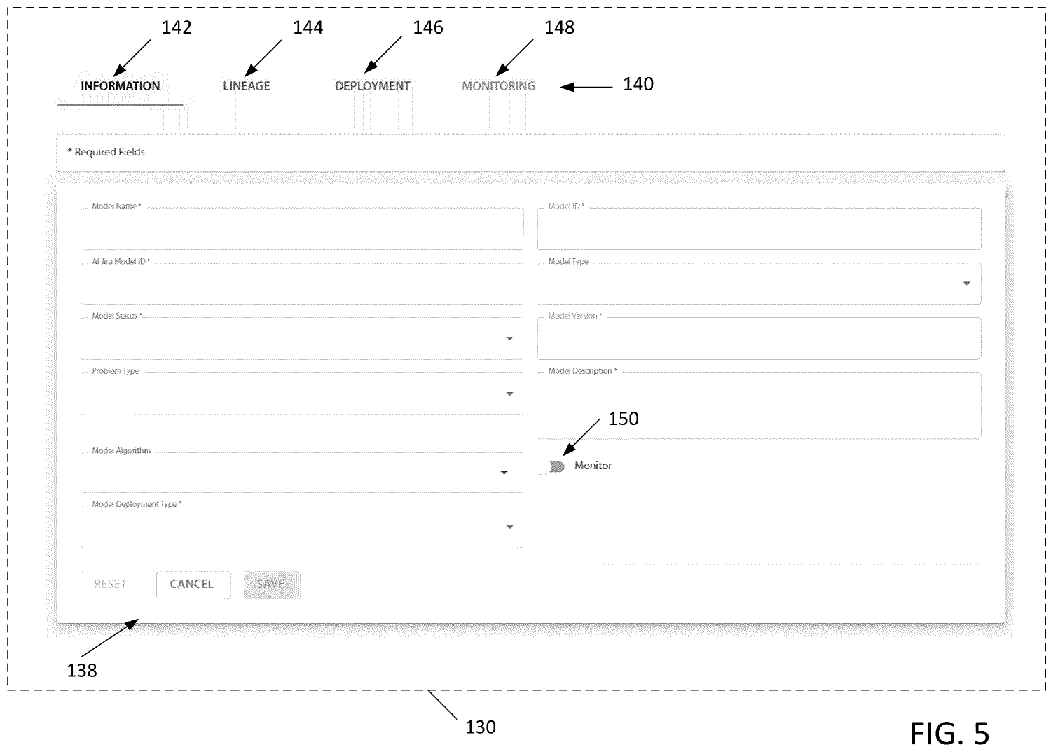

FIGS. 5, 6, 7, and 8 show, respectively, further example user interfaces 130, 132, 134, 136 generated by the template of FIG. 3 according to a further embodiment of the template.

Together, the user interfaces 130, 132, 134 and 136 provide a model building and deployment platform presented via a graphical display that receives inputs for processing via the MAF driver 22 (FIG. 1).

Some of the interfaces include buttons 138 for resetting or saving information entered into the various data fields of the interface, or to cancel building of the model prior to deploying the model or an update to the model.

Some of the data entry fields provided by the user interfaces 130, 132, 134 and 136 include drop down menus with pre-populated selectable options (e.g., pathways to scripts or data storage locations) as described above in connection with FIG. 4. Other data entry fields configured for manual data entry.

Referring to FIG. 5, the interface 130 includes a model building and deployment dashboard 140. The dashboard 140 includes selectable tabs for building the model to be deployed in a structured manner. The tabs include an information tab 142, a lineage tab 144, a deployment tab 156, and a monitoring tab 148.

In FIG. 5, the information tab 142 has been selected, and the user is prompted, via the interface 130, to enter specified categories of information about the model to be deployed into discrete data entry fields. This information includes, for example, a model name, a model ID, a model type, a model status (e.g., in training, in production), a model version, a problem addressed by the model, a model description, an algorithm used by the model, and a model deployment type (e.g., batch scoring or real-time scoring).

In addition, a toggle 150 can be slid on or off to select whether the model being built and deployed requires monitoring following deployment.

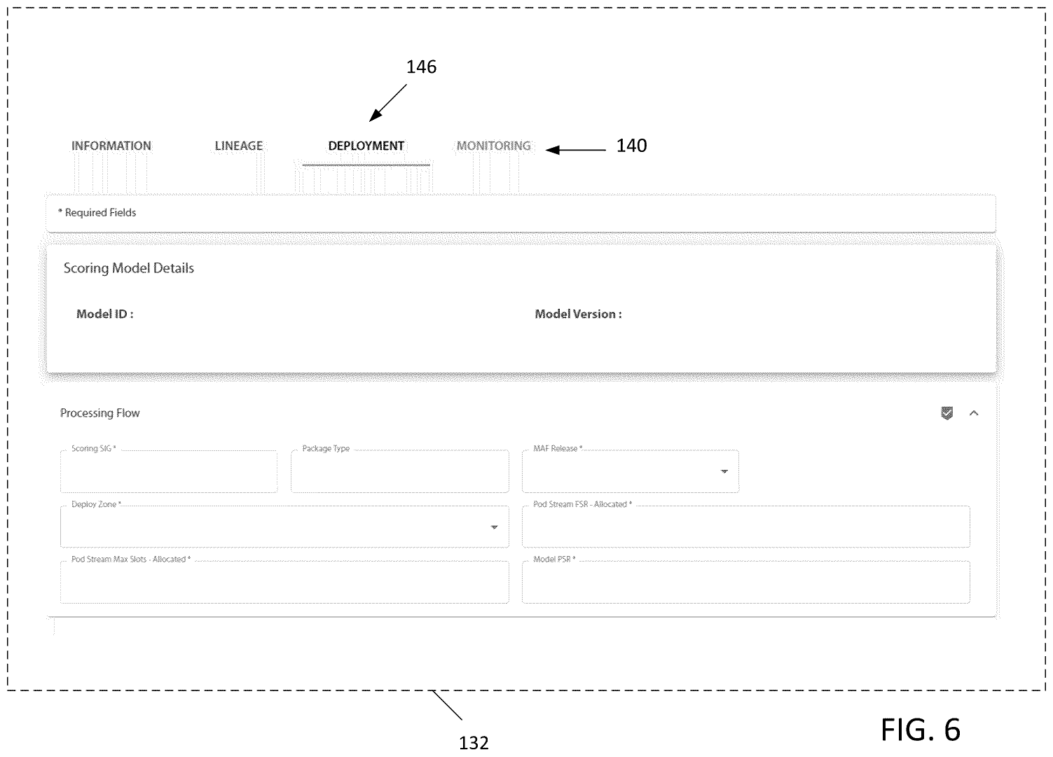

Referring to FIG. 6, the deployment tab 146 has been selected, and the user is prompted, via the interface 132, to enter operating factors that dictate how and where the model is deployed into discrete data entry fields. The operating factors include, for example, server configuration and/or resource allocation for any jobs executed by the model, a package type for the model, a version of the MAF driver 22 (FIG. 1) to be used to deploy the model, hardware and software integration factors for deploying the model, a deployment zone, and so forth.

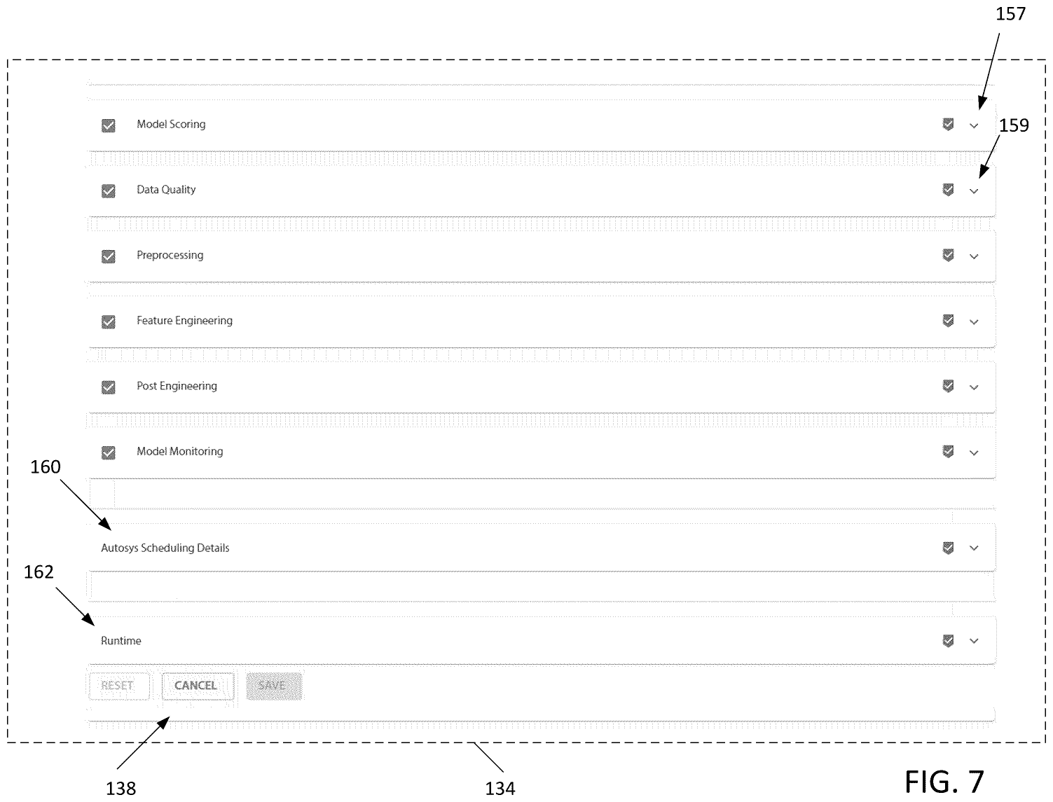

Referring to FIG. 7, the deployment tab 146 (FIG. 6) has been selected, and the user is prompted via the interface 134 to select any of a discrete set of jobs required by the model using toggle buttons associated with the jobs. The jobs include model scoring, data quality, preprocessing, feature engineering, post scoring engineering, and model monitoring. In this example, the model being built and deployed requires all of these tools. In other examples, a model may only require a subset of these tools, and only that subset of tools are selected using the interface 134.

Each selected job has an associated drop down menu for entering specific configuration information associated with that job. The interface 134 also provides drop down menus to select operating factors associated with the deployment of the model, including scheduling and runtime (e.g., job dependency) operating factors.

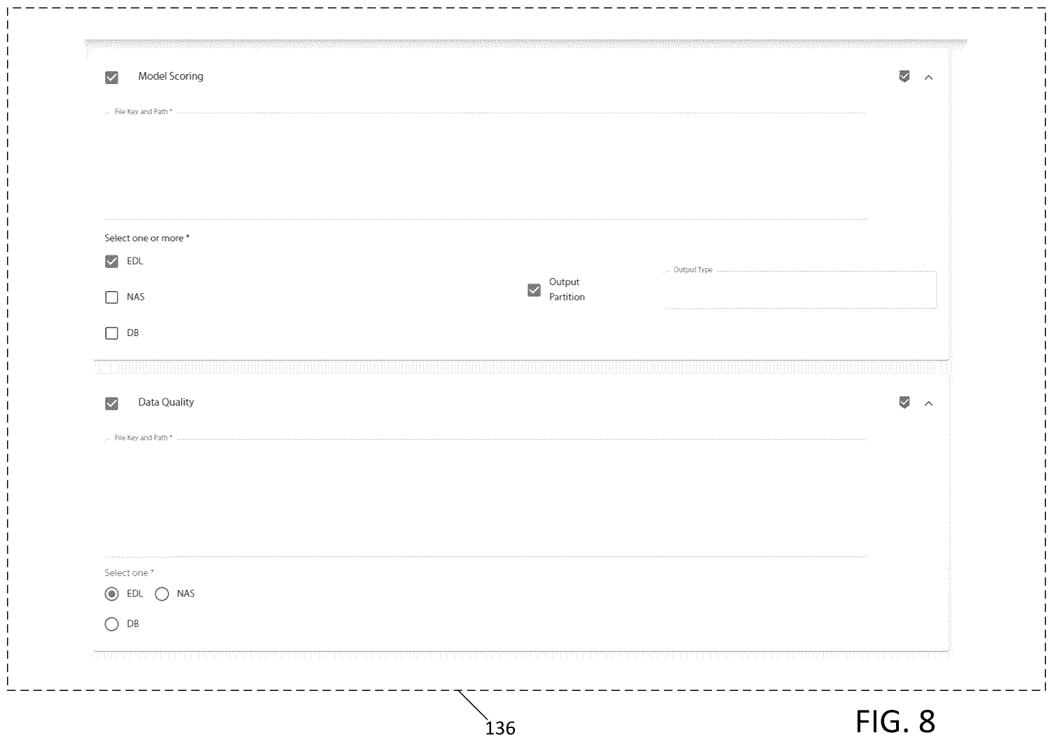

Referring to FIG. 8, the deployment tab 146 (FIG. 6) has been selected, and the drop down menus 157 and 159 of FIG. 7 have been selected, such that the user is prompted via the interface 136 to enter information (one or more script pathways) that configures the scoring job pipeline of the model upon deployment of the model by the MAF driver 22 (FIG. 1) in an integrated manner. The interface 136 also prompts the user for information (e.g., one or more script pathways) relating to data quality for the model. The interface further prompts the user to select locations to store output from the scoring jobs. As shown, depending on the job, a single repository or multiple repositories can be selected. In some examples, if multiple repositories can be selected, an option is provided via the interface 138 to divide portions of the output from the job between different repositories.

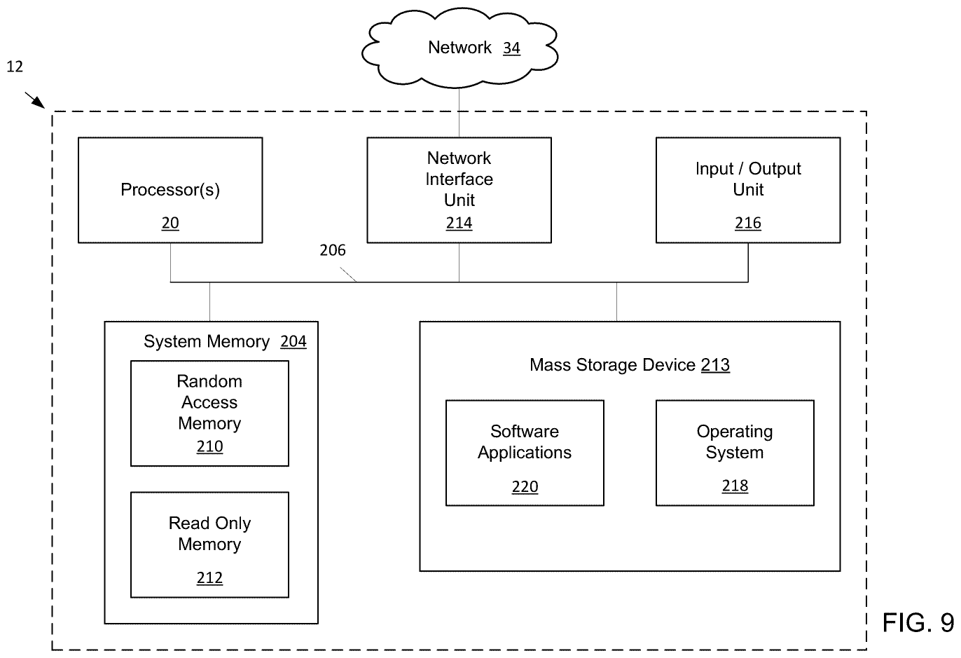

FIG. 9 schematically shows example physical components of portions of the system 10 of FIG. 1. In particular, additional components of the server 12 are illustrated in FIG. 5. In this example, the server 12 provides the computing resources to perform the functionality associated with the system 10 (FIG. 1). The user device 14 and other computing resources associated with the system 10 can be similarly configured.

The server 12 can be an internally controlled and managed device (or multiple devices) of the business enterprise, e.g., the financial institution. Alternatively, the server 12 can represent one or more devices operating in a shared computing system external to the enterprise or institution, such as a cloud. Further, the other computing devices disclosed herein can include the same or similar components, including the user device 14.

Via the network 34, the components of the server 12 that are physically remote from one another can interact with one another.

The server 12 includes the processor(s) 20, a system memory 204, and a system bus 206 that couples the system memory 204 to the processor(s) 20.

The system memory 18 includes a random access memory (“RAM”) 210 and a read-only memory (“ROM”) 212. A basic input/output system that contains the basic routines that help to transfer information between elements within the server 12, such as during startup, is stored in the ROM 212.

The server 12 further includes a mass storage device 213. The mass storage device 213 can correspond to the memory 18 of the system 10 (FIG. 1). The mass storage device 213 is able to store software instructions and data, such as MAF driver 22, the training data 41, and the scoring data 43 (FIG. 1).

The mass storage device 213 is connected to the processor(s) 20 through a mass storage controller (not shown) connected to the system bus 206. The mass storage device 213 and its associated computer-readable data storage media provide non-volatile, non-transitory storage for the server 12. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server 12.

According to various embodiments of the invention, the server 12 may operate in a networked environment using logical connections to remote network devices through the network 34, such as a wireless network, the Internet, or another type of network. The server 12 may connect to the network 34 through a network interface unit 214 connected to the system bus 206. It should be appreciated that the network interface unit 214 may also be utilized to connect to other types of networks and remote computing systems. The server 12 also includes an input/output unit 216 for receiving and processing input from a number of other devices, including a touch user interface display screen, an audio input device, or another type of input device. Similarly, the input/output unit 216 may provide output to a touch user interface display screen or other type of output device, including, for example, the I/O device 31 (FIG. 1).

As mentioned briefly above, the mass storage device 213 and/or the RAM 210 of the server 12 can store software instructions and data. The software instructions include an operating system 218 suitable for controlling the operation of the server 12. The mass storage device 213 and/or the RAM 210 also store software instructions and applications 220, that when executed by the processor(s) 20, cause the server 12 to provide the functionality described above.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer implemented method, comprising:
generating, with at least one graphical user interface, a template for a model associated with a project of an enterprise, the template including, for each of a plurality of jobs of the model, respective selectable options for an output location for storing a job output, the selectable options including, for each of the plurality of jobs, at least two data repositories that are remote from each other;
receiving, with the at least one graphical user interface and via the template, selections of the plurality of jobs of the model, for each of the plurality of jobs, an output selection of one of the respective selectable options for the output location, and selections of scripts for running the plurality of jobs of the model;
receiving, with the at least one graphical user interface, a selection of a computing environment from a plurality of computing environments of the enterprise to provide a selected computing environment, the selection of the computing environment being received via the template;
deploying the model in the selected computing environment of the enterprise, including using the template to configure and perform the plurality of jobs based on the scripts, the using including integrating the scripts from the selection with a driver to provide integrated scripts that are compatible with one another in the selected computing environment, the deploying including, for each of the plurality of jobs, storing the job output in one of the at least two data repositories corresponding to the output selection;
for a first of the plurality of jobs:
(i) accessing the job output of a second of the plurality of jobs from the one of the at least two data repositories selected for the second of the plurality of jobs; and
(ii) using the output of the second of the plurality of jobs to generate the output of first of the plurality of jobs; and
running the plurality of jobs of the model in the selected computing environment to generate model output for the project based on the integrated scripts.

2. The method of claim 1, further comprising packaging the model based on input received via the template such that the model is operatively linked with another model as a package.

3. The method of claim 1, wherein the model includes a machine learning algorithm.

4. The method of claim 1, wherein the plurality of jobs includes data processing for the model.

5. The method of claim 1, wherein the plurality of jobs includes feature engineering for the model.

6. The method of claim 1, wherein the plurality of jobs includes scoring the model.

7. The method of claim 6, wherein the plurality of jobs includes at least one post-scoring job.

8. The method of claim 7, wherein the at least one post-scoring job includes monitoring the scoring in real-time.

9. The method of claim 7, wherein the at least one post-scoring job includes auditing the model output.

10. The method of claim 9, wherein the at least one post-scoring job is configured to determine errors in the scoring.

11. The method of claim 1, wherein the deploying includes implementing an operating factor for running at least one of the plurality of jobs, the operating factor being provided using the template.

12. The method of claim 11, wherein the operating factor defines a dependency of starting one of the plurality of jobs upon completion of another job.

13. The method of claim 12, wherein a selection of the another job is received via the template and received with the at least one graphical user interface.

14. The method of claim 1, further comprising:
receiving, with the at least one graphical user interface, a selection, received via the template, of an input path for each of the plurality of jobs.

15. The method of claim 11, wherein the operating factor causes the model to score, based on an operating factor selection received via the template, either in real-time or using batch processing.

16. A system, comprising:
at least one processor;
a graphical display; and
non-transitory computer-readable storage storing instructions that, when executed by the at least one processor, cause the at least one processor to:
generate, with at least one graphical user interface displayed on the graphical display, a template for a model associated with a project of an enterprise, the template including, for each of a plurality of jobs of the model, respective selectable options for an output location for storing a job output, the selectable options including, for each of the plurality of jobs, at least two data repositories that are remote from each other;
receive, with the at least one graphical user interface, selections of scripts for running the plurality of jobs of the model, the selections of scripts being received via the template;
receive, for each of the plurality of jobs, via the template and with the at least one graphical user interface, an output selection of one of the respective selectable options for the output location;
receive, with the at least one graphical user interface, a selection of a computing environment from a plurality of computing environments of the enterprise to provide a selected computing environment, the selection of the computing environment being received via the template;
deploy the model in the selected computing environment of the enterprise, including to use the template to configure and perform the plurality of jobs, to use including to integrate the scripts from the selection with a driver to provide integrated scripts that are compatible with one another in the selected computing environment, to deploy including, for each of the plurality of jobs, to store the job output in one of the at least two data repositories corresponding to the output selection;
for a first of the plurality of jobs:
(i) access the job output of a second of the plurality of jobs from the one of the at least two data repositories selected for the second of the plurality of jobs; and
(ii) use the output of the second of the plurality of jobs to generate the output of first of the plurality of jobs; and
run the plurality of jobs of the model in the selected computing environment to generate model output for the project based on the integrated scripts.

17. The system of claim 16, wherein the plurality of jobs includes data processing for the model, feature engineering for the model, scoring the model, and at least one post-scoring job.

18. The system of claim 16, wherein to deploy includes to implement an operating factor for running at least one of the plurality of jobs, the operating factor being provided using the template.

19. The system of claim 18, wherein the operating factor defines a dependency of starting one of the plurality of jobs upon completion of another job.

20. A computer implemented method, comprising:
generating, with at least one graphical user interface, a template for a model associated with a project of an enterprise, the template including, for each of a plurality of jobs of the model, respective selectable options for an output location for storing a job output, the selectable options including, for each of the plurality of jobs, at least two data repositories that are remote from each other;
receiving, with the at least one graphical user interface and via the template, selections of the plurality of jobs of the model, for each of the plurality of jobs, an output selection of one of the respective selectable options for the output location, selections of scripts for running the plurality of jobs of the model, and a selection, for each of the plurality of jobs, of an input path, the plurality of jobs including data processing for the model, feature engineering for the model, scoring the model, and at least one post-scoring job;
receiving, with the at least one graphical user interface, a selection of a computing environment from a plurality of computing environments of the enterprise to provide a selected computing environment, the selection of the computing environment being received via the template;
deploying the model in the selected computing environment of the enterprise, including using the template to configure and perform the plurality of jobs based on the scripts, the using including integrating the scripts from the selection with a driver to provide integrated scripts that are compatible with one another in the selected computing environment, the deploying including, for each of the plurality of jobs, storing the job output in one of the at least two data repositories corresponding to the output selection, the deploying further including implementing operating factors for running the plurality of jobs, the operating factors being provided using the template, the operating factors including defining a dependency of starting one of the plurality of jobs upon completion of another job, the operating factors further causing the model to score, based on an operating factor selection received via the template, either in real-time or using batch processing;
for a first of the plurality of jobs:
(i) accessing the job output of a second of the plurality of jobs from the one of the at least two data repositories selected for the second of the plurality of jobs; and
(ii) using the output of the second of the plurality of jobs to generate the output of first of the plurality of jobs; and
running the plurality of jobs of the model in the selected computing environment to generate model output for the project based on the integrated scripts, the running including running each of the plurality of jobs and, for each of the plurality of jobs, storing the job output in the output location corresponding to the one of the respective selectable options for the output location.
